(19) United States
(12) Patent Application Publication
(10) Pub. No.: US 2003/0092567 A1
(43) Pub. Date: May 15, 2003

(54) Ceramic catalyst body

(76) Inventors: Masakazu Tanaka, Okazaki-City (JP); Tosiharu Kondo, Toyoake-City (JP); Takumi Suzawa, Okazaki-City (JP); Jun Hasegawa, Hekinan-City (JP); Tomohiko Nakanishi, Nishio-shi (JP); Tomomi Hase, Kariya-City (JP)

Correspondence Address: Nixon & Vanderhye P.C., 8th Floor, 1100 North Glebe Road, Arlington, VA, 22201-4714, US

(21) Appl. No.: 10/290,325

(22) Filed: Nov. 8, 2002

(30) Foreign Application Priority Data
Nov. 12, 2001 (JP) 2001-345824
Jul. 4, 2002 (JP) 2002-195866

(51) Int. Cl. B01J 23/10

(52) U.S. Cl. 502/302; 502/349; 502/527.12; 502/313

(57) ABSTRACT

The present invention provides a ceramic catalyst body having low thermal capacity and low pressure loss, is capable of demonstrating various catalytic actions according to the application, and has high catalyst performance and practical usefulness.

In the present invention, a main catalyst component such as a catalytic precious metal and a co-catalyst component such as ceria are loaded directly onto a support surface by substituting a portion of the composite elements of a base ceramic, and using a ceramic support capable of directly bonding to the substitution element. As a result, bonding strength with the support is increased by a transition metal put into solid solution in the co-catalyst component, the need for a coating layer is eliminated, and high durability, low thermal capacity and low pressure loss are obtained.

### BACKGROUND OF THE INVENTION

1. Field of the Invention

The present invention relates to a ceramic catalyst body applied, for example, to a catalyst for purification of the exhaust gas of automobile engines.

2. Description of the Related Art

Exhaust gas purification catalysts that have been widely used in the past conventionally employ a cordierite honeycomb structural body having high resistance to thermal shock for the catalyst support, and after coating their surface with γ-alumina, are loaded with a precious metal catalyst. The reason for forming a coating layer is that, due to the small specific surface area of the cordierite, it would not be possible to load the required amount of catalyst component unless the coating layer was formed. Consequently, the catalyst is loaded after first increasing the surface area of the support using γ-alumina, a material having a high specific surface area.

However, since coating the cell wall surfaces of the support with γ-alumina invites an increase in thermal capacity, this is disadvantageous in terms of early activation of the catalyst. In addition, there was also the problem of the coefficient of thermal expansion of the support being larger than that of the cordierite alone, causing a decrease in the cell opening surface area and a resulting increase in pressure loss.

Consequently, various studies have been conducted on ceramic body that can be loaded with a catalyst component without forming a coating layer. For example, Japanese Examined Patent Publication No. 5-50338 proposes a method for improving the specific frontal area of cordierite itself by treating with acid followed by treating with heat. However, in this method, the crystal lattice of the cordierite is destroyed by this acid treatment and heat treatment resulting in the problem of decreased strength, thereby making this impractical.

In contrast, the inventors of the present invention proposed a ceramic support that can be directly loaded with the required amount of catalyst component without forming a coating layer to improve specific surface area (Japanese Patent Application No. 2000-104994). In this ceramic support, fine pores are formed that are capable of being loaded directly with a catalyst component by replacing at least one type or more of the elements that compose the base ceramic with an element having a different valence number. This ceramic support is not susceptible to the problem of decreased strength accompanying acid treatment and heat treatment as in conventional supports, and can be expected to be applied in various applications.

On the other hand, from the viewpoint of protecting the global environment, restrictions on automobile emissions have been tightened in recent years, and as a measure for accommodating these restrictions, various co-catalyst components have been loaded in exhaust gas purification catalysts to improve catalyst performance. Therefore, the inventors of the present invention attempted to fabricate such a catalyst using the above ceramic support capable of being directly loaded with a catalyst component. However, in the case of loading a co-catalyst in particular, since the holding force of the co-catalyst to the ceramic support is weaker than that of precious metal catalysts, it was determined that there is the risk of the effect of the co-catalyst component being unable to be adequately demonstrated.

### SUMMARY OF THE INVENTION

In consideration of the above circumstances, the object of the present invention is to obtain a ceramic catalyst body provided with both high catalyst performance and practicality which, together with being able to decrease thermal capacity and pressure loss, is able to demonstrate various catalytic effects according to the application.

The ceramic catalyst body of a first aspect of the invention comprises the loading of a main catalyst component and co-catalyst component onto a ceramic support. The above ceramic support is a ceramic support capable of directly loading a catalyst component on the surface of a base ceramic, and is characterized by the above main catalyst component and the above co-catalyst component being loaded directly onto said ceramic support. As a result of both a main catalyst component and co-catalyst component being loaded directly onto the support surface, both thermal capacity and pressure loss are low, and the addition of the co-catalyst component allows the demonstration of various catalytic effects.

Preferably, if a co-catalyst component that contains an oxygen storage component is used for the above co-catalyst component, oxygen is able to leave and enter according to the oxygen concentration, thereby enhancing the action of the main catalyst component. In addition, if the above co-catalyst component contains a transition metal element, bonding strength with the above ceramic support is enhanced, thereby improving durability.

The above transition metal element can be put into solid solution or substituted with an oxygen storage component. Moreover, bonding is enhanced when the above transition metal element is put into solid solution or substituted with an oxygen storage component, and the above co-catalyst component is loaded directly by bonding the above transition metal element to the base ceramic of the above ceramic support.

According to a second aspect of the invention, another ceramic catalyst body is provided for solving the above problems, and the above ceramic support is a ceramic support that enables a catalyst component to be loaded directly onto the surface of a base ceramic. When the above main catalyst component is loaded directly onto said ceramic support, while on the other hand, a co-catalyst layer is formed that contains the above co-catalyst component on the surface of the above ceramic support, the loaded amounts of main catalyst component and co-catalyst component can be increased while minimizing thermal capacity and pressure loss, thereby making it possible to improve catalyst performance.

More specifically, according to a third aspect of the invention, a constitution can be employed in which, in addition to the above main catalyst component being loaded directly onto the above ceramic support, a co-catalyst layer is formed comprising directly coating the above co-catalyst component onto the surface of the above ceramic support.

Alternatively, according to a fourth aspect of the invention, in addition to the above main catalyst component being loaded directly onto the above ceramic support, a co-catalyst component layer can also be formed comprising coating the above co-catalyst component onto the surface of the above ceramic support along with an intermediate base material.

At this time, the above co-catalyst layer is formed by coating the above co-catalyst component onto an intermediate base material layer formed on the surface of the above ceramic support, or coating an intermediate base layer pre-loaded with the above co-catalyst component onto the surface of the above ceramic support.

According to a fifth aspect of the invention, another ceramic catalyst body is provided for solving the above problems that is a ceramic support capable of directly loading a catalyst component onto the surface of a base ceramic, and together with at least a portion of the above main catalyst component and co-catalyst component being loaded directly onto the above ceramic support, a catalyst layer is formed on the surface of the above ceramic support that contains the remaining main catalyst component and co-catalyst component. In this constitution, since the loading method can be selected according to the catalyst component, catalyst deterioration is inhibited, and satisfactory catalyst performance is obtained.

More specifically, the above catalyst layer can be formed by coating the above main catalyst component or co-catalyst component onto an intermediate base material layer formed on the surface of the above ceramic support, or by coating an intermediate base material pre-loaded with the above main catalyst component or co-catalyst component onto the surface of the above ceramic support.

For example, one or more types of catalyst metal can be used for the above main catalyst component, and together with containing or loading a portion of that metal in the above intermediate base material layer, the remaining catalyst metal can be loaded directly onto the above ceramic support. Since the distance between the above catalyst metal and the above co-catalyst component decreases, the properties of the above co-catalyst component can be demonstrated effectively. In addition, low-temperature activity performance improves as a result of it becoming easier for the above catalyst metal to appear on the surface.

The above intermediate base material should be one or more types selected from, for example, Al₂O₃, SiO₂, MgO, TiO₂, ZrO₂, zeolite, silicalite and mordenite that has a specific surface area larger than that of the base ceramic of the above ceramic support.

Preferably, an oxide is used for the above oxygen storage component that contains at least one or types of elements selected from lanthanide elements as well as Y, Zr and Hf.

The effects of inhibiting increases in thermal capacity and pressure loss are enhanced by making the thickness of the above co-catalyst layer or the above catalyst layer 100 μm or less. Preferably, high catalyst performance, low thermal capacity and low pressure loss can all be realized by making the thickness of the above co-catalyst layer or the above catalyst layer 0.5-95 μm.

The above ceramic support can be a support in which at least one or more types of the elements that compose the above base ceramic are substituted with an element other than the composite elements, and which is capable of directly loading the above catalyst component or the above co-catalyst component with respect to the substitution element.

More specifically, if the above catalyst component or the above co-catalyst component are loaded onto the above substitution element by chemical bonding, since retention is improved and the catalyst component is uniformly dispersed in the support and resistant to aggregation, there is little deterioration due to long-term use.

Preferably, at least one or more types of an element having a d or f orbital in its electron orbitals is used for the above substitution element. Since elements having a d or f orbital in their electron orbitals easily bond with catalyst metals, bonding strength can be improved.

Preferably, since a ceramic having cordierite for its main component is used for the above base ceramic, and cordierite has superior thermal shock resistance, it is suitable for use as a catalyst body for automobile exhaust gas.

Preferably, the above ceramic support has a large number of fine pores capable of directly loading a catalyst onto the surface of a base ceramic, and a support capable of directly loading the above catalyst component or the above co-catalyst component is used for these fine pores.

More specifically, the above fine pores are composed of at least one type of defect in the ceramic crystal lattice, fine cracks in the ceramic surface and deficiency in the elements that compose the ceramic.

The width of the above fine cracks is preferably 100 nm or less in terms of ensuring support strength.

In order to enable loading of a catalyst component, the above fine pores should have a diameter or width of 1000 times or less the diameter of the catalyst ions that are loaded, and if the number of the above fine pores is 1×10¹¹/L or more at this time, an amount of catalyst component can be loaded that is equal to the loaded amount of the prior art.

Moreover, if a ceramic having cordierite for its main component is used for the above base ceramic, due to its superior thermal shock resistance, it is suitable for use as a catalyst body for automobile exhaust gas. This is because the above fine pores are defects formed by substitution of a portion of the composite elements of the cordierite with metal elements having a different valence number.

In this case, the above defects are composed of at least one type of oxygen defect or lattice defect, and are formed by substituting a portion of the composite elements of the cordierite with elements having a different valence number. If 4×10⁻⁶% of cordierite crystals having one or more of the above defects are made to be contained in the unit crystal lattice of the cordierite, an amount of catalyst metal can be loaded that is equal to the loaded amount of the prior art.

### BRIEF DESCRIPTION OF THE DRAWINGS

FIGS. 1(a) and 1(b) indicate a first embodiment of the present invention, with FIG. 1(a) being a drawing schematically showing the main constitution of a ceramic catalyst body, and FIG. 1(b) being a drawing schematically showing the form of loading a co-catalyst component onto the surface of a ceramic support.

FIG. 2(a) is a drawing showing the relationship between the loaded amount of catalyst component and purification rate, while FIG. 2(b) is a drawing showing the relationship between the amount of loaded catalyst required to obtain equal purification performance and average particle diameter based on a total surface area per g of 0.028 m².

FIG. 3(a) is a drawing schematically showing the main constitution of a ceramic catalyst body that uses a co-catalyst component not containing a transition metal, while FIG. 3(b) is a drawing showing a comparison of the bonding strengths of a main catalyst component and co-catalyst component.

FIG. 4 is a drawing schematically showing the main constitution of a ceramic catalyst body of a second embodiment of the present invention.

FIG. 5 is a drawing schematically showing the main constitution of a ceramic catalyst body of a third embodiment of the present invention.

FIG. 6 is a drawing showing the relationship between the thickness of the catalyst layer and the T50 purification temperature.

FIGS. 7(a) and 7(b) show a fourth embodiment of the present invention, with FIG. 7(a) being a drawing schematically showing the main constitution of a ceramic catalyst body, and FIG. 7(b) being a drawing for explaining the production method of a ceramic catalyst body.

FIG. 8(a) is a drawing schematically showing the main constitution of a ceramic catalyst body representing a fifth embodiment of the present invention, while FIG. 8(b) is a drawing schematically showing the main constitution of a ceramic catalyst body that does separately load a main catalyst component.

FIGS. 9(a) and 9(b) are drawings showing a fifth embodiment of the present invention, with FIG. 9(a) being a drawing showing the effects of improving oxygen storage ability in the case a catalyst layer formed on the surface of a ceramic catalyst body contains a main catalyst component, while FIG. 9(b) is a drawing showing the relationship between separate loading of a main catalyst component and T50 purification temperature.

### DESCRIPTION OF THE PREFERRED EMBODIMENTS

The following provides an explanation of embodiments of the present invention. The ceramic catalyst body of the present invention is preferably used for an automobile exhaust gas purification catalyst and so forth, uses a ceramic support capable of directly loading a catalyst component onto the surface of a base ceramic, and loads a main catalyst component and co-catalyst component onto this ceramic support as catalyst components. Normally, a material having for its main component cordierite represented with the theoretical composition 2MgO.Al₂O₃.5SiO₂ is preferably used for the base ceramic of the ceramic support capable of directly loading a catalyst component (to be referred to as the direct loading ceramic support), and this material exhibits high heat resistance. In addition, examples of other ceramics that may be used besides cordierite include alumina, spinel, aluminum titanate, silicon carbide, mullite, silica-alumina, zeolite, zirconia, silicon nitride and zirconium phosphate. Although the support is preferably formed into, for example, a honeycomb shape in the case of a catalyst used for purification of automobile exhaust gas, it is not necessarily limited to a honeycomb shape, but rather may be in the form of other shapes such as pellets, powder, foam, hollow fibers or fibers.

A ceramic support having a large number of elements that allow the direct loading of a catalyst component onto the surface of a base ceramic is preferably used for the direct loading ceramic support. A chemical component can be loaded without forming a coating layer of γ-alumina and so forth by chemically bonding the chemical component to this element. The elements that allow direct loading of a catalyst component are elements other than the elements that compose the base ceramic, are able to chemically bond with the catalyst component, and are introduced by being substituted for at least one or more types of elements that compose the base ceramic. For example, in the case of cordierite, an element having greater bonding strength with the loaded chemical component than the elements that compose the ceramic and which are capable of bonding the catalyst component by chemical bonding is used for the element substituted for the Si, Ai or Mg that are composite elements of the ceramic, excluding oxygen. More specifically, examples of these elements include elements having a different valence number from these composite elements and having a d orbital or f orbital in their electron orbitals, and an element is preferably used that either has a vacant d orbital or f orbital or has two or more oxidation states. Since elements having a vacant d orbital or f orbital have an energy level close to the loaded catalyst component enabling electrons to be shared easily, they bond easily with the catalyst component. In addition, elements having two or more oxidation states also share electrons easily and can be expected to exhibit similar effects.

Specific examples of elements having a vacant d orbital or f orbital include W, Ti, V, Cr, Mn, Fe, Co, Ni, Zr, Mo, Ru, Rh, Ce, Ir and Pt, and at least one or more types of these elements can be used. Among these elements, W, Ti, V, Cr, Mn, Fe, Co, Mo, Ru, Rh, Ce, Ir and Pt have two or more oxidation states. Other specific examples of elements having two or more oxidation states include Cu, Ga, Se, Pd, Ag and Au.

In the case of substituting a ceramic composite element with these substitution elements, a method can be employed in which a raw material of the substitution element is added and kneaded into the ceramic raw material during preparation of the ceramic raw material. In this case, a portion of the raw material of the substitution element to be substituted is reduced in advance corresponding to the substituted amount. Subsequently, after molding and drying the kneaded raw material mixture using ordinary methods, it is degreased and fired in an air atmosphere. Alternatively, a ceramic raw material in which a portion of the raw material of the substitution element to be substituted has been reduced in advance can be kneaded, molded and dried using ordinary methods, followed by impregnating in a solution containing a substitution element to add substitution element. After moving the molded compact impregnated with substitution element from the solution and drying, it is similarly degreased and fired in an air atmosphere. If a method is used in which a substitution element is impregnated into a molded compact in this manner, a large amount of substitution element can be made to be present on the molded compact surface, thereby making this more effective since the substitution element rises on the surface during firing making it easy to form a solid solution.

The amount of substitution element should be such that the total substituted amount is within the range of 0.01-50%, and preferably 5-20%, of the atomic number of the substituted composite element. Furthermore, in the case the substitution element is an element having a different valence number from the composite element of the base ceramic, although lattice defects or oxygen defects occur simultaneously corresponding to the difference in valence number, if a plurality of substitution elements are used and the sum of the oxidation numbers of the substitution elements is made to be equal to the sum of the oxidation numbers of the substituted composite elements, defects do not occur. Thus, steps should be taken in this manner so that there is no change in the overall valence number when not desiring to cause the occurrence of defects and so forth.

A high-performance ceramic catalyst body that takes advantage of the properties of the base ceramic is obtained by loading a main catalyst component and co-catalyst component onto this direct loading ceramic support. Here, a characteristic of the present invention lies in the loading form of the catalyst components, and especially the co-catalyst component, and this is indicated in (1) through (4) below.

(1) Both a main catalyst component and co-catalyst component are loaded directly by bonding with substitution elements of a direct loading ceramic support.

(2) The main catalyst component is loaded directly by bonding with a substitution element of a direct loading catalyst support, and the co-catalyst component is coated onto the surface of a direct loading catalyst support to form a co-catalyst layer.

(3) The main catalyst component is loaded directly by bonding with a substitution element of a direct loading catalyst support, and the co-catalyst component is coated onto the surface of a direct bonding catalyst support along with an intermediate base material to form a co-catalyst layer.

(4) At least a portion of a main catalyst component and a co-catalyst component are loaded directly by bonding with substitution elements of a direct loading ceramic support, and the remaining main catalyst component and co-catalyst component are coated onto the surface of a direct loading ceramic support together with an intermediate base material or without using an intermediate base material to form a catalyst layer.

Since the properties and performance of the resulting ceramic catalyst body differ according to differences in the loaded forms of the catalyst components, they may be used according to the specific requirements. The following provides an explanation of the details of (1) through (4) based on the drawings.

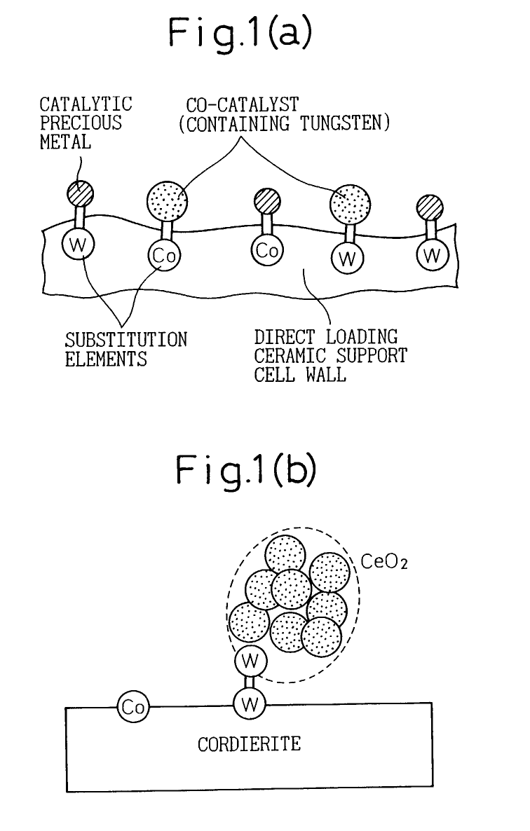

FIGS. 1(a) and 1(b) indicate a first embodiment of the present invention, and shows a ceramic catalyst body having the holding form of (1) above. In the direct loading ceramic support of FIG. 1(a), for example, substitution elements in the form of W and Co are introduced into cordierite serving as the base ceramic, and a main catalyst component in the form of a catalytic precious metal along with a co-catalyst component are chemically bonded to a large number of these substitution elements present on cell wall surfaces formed into a honeycomb structure. Catalytic precious metals such as Pt, Rh and Pd are suitably used for the main catalyst component, and one or more types are used as necessary. Metal elements and so forth other than these can also naturally be used for the main catalyst component.

Various components can be used for the co-catalyst component according to the purpose. In the case of a three-way automobile catalyst, for example, an oxygen storage component having the ability to store oxygen is used, and this catalyst has the action of allowing oxygen to enter and leave corresponding to variations in the ambient oxygen concentration. An oxide or compound oxide containing at least one or more types of elements selected from lanthanide elements such as Ce or La as well as elements such as Y, Zr and Hf are normally used for the oxygen storage component. Specific examples of such oxides or compound oxides include ceria (CeO₂) and ceria/zirconia solid solution (CeO₂/ZrO₂). Although the valence number of Ce of an oxygen storage component such as CeO₂ is 4+ when the atmospheric oxygen concentration is high, if the oxygen concentration decreases, the valence number changes to 3+, and since electrical neutrality is disturbed by the change in valence number, electrical neutrality is maintained by desorbing or adsorbing oxygen. Namely, this oxygen storage component has a function that adjusts the air-fuel ratio to maximize catalyst function by adsorbing or desorbing oxygen. In a ceria/zirconia solid solution, the zirconia has the effect of improving heat resistance, thus when desiring to increase the amount of oxygen stored, a ceria-rich co-catalyst component should be used (e.g., 70 wt % CeO₂/30 wt % ZrO₂), and when desiring to enhance heat resistance, a zirconia-rich co-catalyst component should be used (e.g., 10 wt % CeO₂/90 wt % ZrO₂).

However, since the oxygen storage component used as the co-catalyst component is normally an oxide, in comparison with the catalytic precious metal used for the main catalyst component, the bonding strength with substitution elements such as W or Co introduced into the cordierite is weak. Therefore, a transition metal element is preferably introduced as a second element into the oxide or compound oxide serving as the oxygen storage component. Specific examples of transition metal elements include W, Ti, V, Cr, Mn, Fe, Co, Ni, Cu, Zr, Mo, Ru, Rh, Ce, Ir, Pt, Pd, Ag and Au, and at least one type or more than one type of these elements can be used.

Although there is increased susceptibility to thermal aggregation and the risk of deterioration if the bonding strength of the co-catalyst component is weak, as shown in FIG. 1(b), a transition metal element within the co-catalyst component (W in the drawing) can be bonded with a substitution element on the surface of the cordierite (W and Co in the drawing) to increase bonding strength by introducing a transition metal element that bonds easily with the substitution element. Furthermore, in the case of containing a transition metal element as a second component in the co-catalyst component, the transition metal element should preferably be put into solid solution with or substituted for the first component in the form of the oxygen storage component.

Loading of the catalyst components is carried out by an ordinary method consisting of preparing a solution in which a catalyst component is dissolved in a solvent such as water, and impregnating into a direct loading ceramic support followed by drying and baking. Baking is carried out a temperature of 100 ° C. to up to 1000° C. at which water evaporates, while a temperature of 1000 ° C. or higher results in the risk of deterioration, thereby making this undesirable. As a result, the catalyst component bonds with the substitution element, enabling a prescribed amount of catalyst component to be loaded without a γ-alumina or other coating layer. The loaded amount of catalyst component can be adjusted according to the concentration of catalyst component in the solution, and when desiring to increase the loaded amount of catalyst component, the solution impregnation and baking steps can also be repeated. Although loading of the main catalyst component and co-catalyst component is normally carried out for each component, it can also be carried out simultaneously using a solution containing a plurality of components.

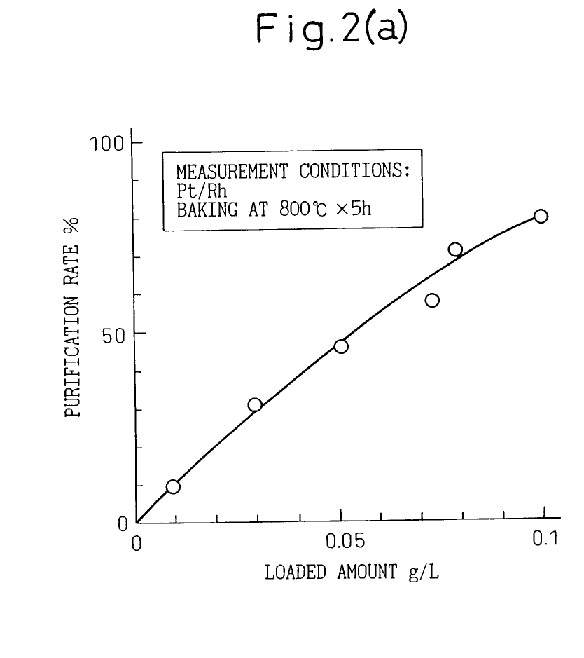

In the case of loading the catalyst component, the average particle diameter of the main catalyst component is 0.39-100 nm, and preferably 50 nm or less, the total surface area per g of main catalyst component is preferably 0.028 m² or more, and the loaded amount of main catalyst component is preferably 0.01 g/L or more. In order to ensure that Pt or other catalytic precious metal is present as crystals, the average particle diameter is required to be 0.39 nm or more, and if it exceeds 100 nm, the surface area per unit weight of the catalyst decreases resulting in poor purification efficiency. As shown in FIG. 2(a), if the loaded amount of main catalyst component is 0.01 g/L or more, purification performance is obtained (purification rate of 10% or more), and if the average particle diameter at this time is 100 nm, the total surface area per g becomes 0.028 m². Preferably, the loaded amount of main catalyst component is 0.05 g/L or more, and the purification rate is 50% or more.

Furthermore, in the present invention, purification performance can be demonstrated effectively with a small loaded amount of catalyst component. This is because a catalyst component is loaded directly onto a substitution element on the surface of a direct loading ceramic support, thereby eliminating the catalyst component that no longer functions as a result of entering fine pores of γ-alumina as in the prior art, and because the catalyst component can be highly dispersed on the support surface at a small catalyst particle diameter due to chemical bonding, thereby improving catalyst efficiency and allowing the obtaining of purification performance equal to or better than that of the prior art with a smaller amount of catalyst. In addition, the amount of catalyst component loaded required for obtaining the desired purification performance can be reduced the smaller the average particle diameter of the catalyst component. FIG. 2(b) shows the relationship between the amount of loaded catalyst required to obtain equal purification performance and average particle diameter based on a total surface area per g of 0.028 m². The loaded amount required for obtaining the desired purification performance varies according to the size of average particle diameter, and it can be understood that a smaller amount is required the smaller the average particle diameter.

In addition, the particle diameter (primary particle diameter) of the co-catalyst component is normally 100 nm or less, and preferably 50 nm or less. Although these particles aggregate to form secondary particles during the course of handling, they return nearly completely to primary particles when dissolved in a solvent. The average particle diameter of the secondary particles is preferably about 1-3 μm. The loaded amount of co-catalyst component should normally be 5 g/L or more.

A high-performance and highly durable ceramic catalyst body is thus obtained by directly loading a main catalyst component and co-catalyst component onto a direct loading ceramic support in this manner without coating γ-alumina and so forth. Since this ceramic catalyst body does not have a γ-alumina coating layer, it has low thermal capacity and low pressure loss, and there is also no decrease in durability due to deterioration of the coating layer. Moreover, oxygen storage ability and so forth can be imparted by adding a co-catalyst component, and in terms of improving catalyst performance, since the main catalyst component and co-catalyst component are chemically bonded, there is reduced susceptibility to the occurrence of catalyst aggregation, thereby enabling it to demonstrate catalytic action over a long period of time.

Next, an example is shown of a production method of the ceramic catalyst body having the constitution shown in FIGS. 1(a) and 1(b). The cordierite raw material was prepared using talc, kaolin, alumina and aluminum hydroxide and substituting 5% of the Si source with W and 5% of the same Si source with Co so as to approach the theoretical composition of cordierite. Suitable amounts of binder, lubricant, moisture retention agent and water were then added to this raw material followed by kneading and molding into a honeycomb shape. The resulting molded compact was fired by holding for 2 hours in an air atmosphere at 1390° C. to obtain a direct loading catalyst support.

A catalytic precious metal in the form of a main catalyst component was first loaded onto the direct loading catalyst support prepared in the above manner followed by loading of a co-catalyst component. Preparation of the co-catalyst component was carried out by preliminarily dissolving cerium chloride, zirconium chloride and aqueous ammonium metatungstenate solution in 1 liter of nitric acid followed by the addition of aqueous ammonium hydroxide solution, neutralization and co-precipitation to obtain a cerium-zirconium-tungsten compound oxide in which the weight ratios of ceria, zirconia and tungsten hydroxide were 9, 81 and 10 wt %, respectively.

A 1 liter aqueous solution was prepared so that the concentrations of catalytic precious metals in the form of platinum nitrate tetraamine and rhodium acetate were 0.075 mol/L and 0.02 mol/L, respectively. The direct loading ceramic support was immersed in a beaker containing this solution, and the beaker with the direct loading ceramic support inside was placed in an ultrasonic cleaner and allowed to stand for 5 minutes. After cleaning, the support was taken out, blown with air and then pre-dried with a microwave dryer for 5 minutes. Next, after carrying out final drying for 1 hour at 110° C., metal sintering was carried out for 2 hours at 300° C. The loaded ratio of the catalytic precious metals after sintering was Pt/Rh=7/1, and the loaded amount was 1.2 g/L.

Next, the co-catalyst component was prepared by placing 45 g of a powder of the cerium-zirconium-tungsten compound oxide prepared in advance and 900 g of pure water in a beaker and stirring with a glass rod. Once the mixture had become uniformly mixed, the support was immersed in the mixture, and the beaker with the support inside were placed in an ultrasonic cleaner. After 5 minutes had elapsed, the support was taken out and blown with air at an air pressure of 0.2 MPa to remove clogging. Subsequently, pre-drying was carried out for 10 minutes with a microwave dryer after which final drying was carried out for 2 hours at 110° C. Following completion of drying, the support was held for 1 hour at 900° C. for the purpose of sintering to complete loading of the catalyst component. The loaded amount of co-catalyst component was 6 g/L.

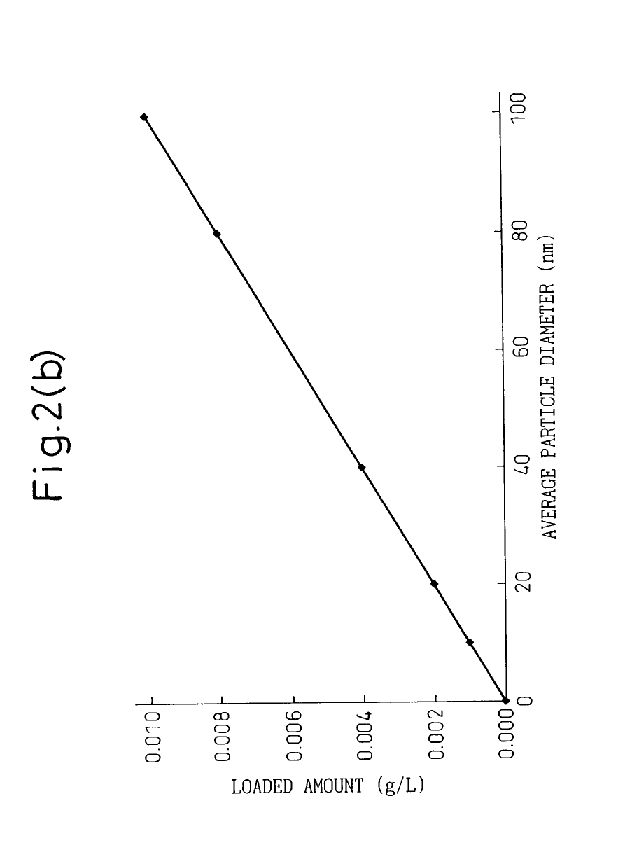

A ceramic catalyst body loaded with the required amounts of a main catalyst component and co-catalyst component according to the above method was confirmed to be obtained. In addition, as shown in FIG. 3(a), a ceramic catalyst body was produced in the same manner as above using a cerium-zirconium compound oxide that did not contain tungsten for the co-catalyst component, and a comparison of the bonding strength of each catalyst component in the ceramic catalyst body is shown in FIG. 3(b). In FIG. 3(b), the bonding strength of the co-catalyst component (cerium-zirconium-tungsten compound catalyst or cerium-zirconium compound catalyst) to the base ceramic in each ceramic catalyst body is shown based on a value of 1.0 for the bonding strength of catalytic precious metal (Pt) to the base ceramic. As shown in FIG. 3(b), bonding strength of 0.8, which is close to that of the catalytic precious metal (Pt), was obtained for the bonding strength ratio of the co-catalyst component to which a transition metal element such as W had been added, and it was determined that the addition of a transition metal element considerably improves bonding strength.

Although a ceramic support was used in the above first embodiment in which a substitution element was introduced that is capable of directly loading a catalyst component, in the present invention, a ceramic support can also be used that has a large number of fine pores capable of directly loading a catalyst component in the surface of a base ceramic. More specifically, fine pores capable of directly loading a catalyst component are comprised of at least one type of defect in the ceramic crystal lattice (oxygen defect or lattice defect), fine cracks in the ceramic surface, or a deficiency of elements that compose the ceramic, or can also be formed by combining a plurality of types. Since the diameter of the catalyst component ions that are loaded is normally about 0.1 nm, fine pores formed in the surface of cordierite are able to load catalyst component ions provided their diameter or width is 0.1 nm or more, and in order to ensure the strength of the ceramic, the width or diameter of the fine pores should preferably be 1000 times (100 nm) or less the diameter of the catalyst component ions, and as small as possible. Preferably, it should be 1-1000 times (0.1-100 nm). In order to retain the catalyst component ions, the depth of the fine pores should preferably be ½ times (0.05 nm) or more their diameter. At this size, in order to load an amount of catalyst component equal to that of the prior art (1.5 g/L), the number of fine pores should be 1×10¹¹/L or more, preferably 1×10¹⁶/L or more, and more preferably 1×10¹⁷ or more.

Among the fine pores formed in the ceramic surface, crystal lattice defects consist of oxygen defects and lattice defects (metal vacant lattice points and lattice strain). Oxygen defects are defects that occur due to a shortage of oxygen for composing the ceramic crystal lattice, and catalyst component can be loaded in fine pores formed due to the absence of oxygen. Lattice defects are lattice defects that occur due to the incorporation of oxygen in an amount beyond that which is necessary for composing the ceramic crystal lattice, and catalyst component can be loaded in fine pores formed due to crystal lattice strain or metal vacant lattice points.

More specifically, if a cordierite honeycomb structural body contains 4×10⁻⁶% or more, and preferably 4×10⁻⁵% or more, of cordierite crystals having one or more of at least one type of oxygen defect or lattice defect per unit crystal lattice, or contains 4×10⁻⁸, and preferably 4×10⁻⁷, of at least one type of oxygen defect or lattice defect per unit crystal lattice of cordierite, the number of fine pores of the ceramic support becomes equal to or greater than the above prescribed number. Such fine pores can be formed according to the method described in Japanese Patent Application No. 2000-104994.

For example, in order to form oxygen defects in a crystal lattice, a method can be employed in which, after molding and degreasing a cordierite raw material containing an Si source, Al source and Mg source, in a firing step, by (1) making the firing atmosphere a reduced pressure or reducing atmosphere, and (2) either creating a shortage of oxygen in the firing environment or starting raw material by firing in an atmosphere having a low oxygen concentration using a compound that does contain oxygen in at least a portion of the raw material, or (3) substituting a portion of at least one type of composite element of the ceramic other than oxygen with an element having a valence number smaller than said element. In the case of cordierite, since the composite elements are Si(4+), Al(3+) and Mg(2+), and all of these have a positive charge, when these are substituted with an element having a smaller valence number, a shortage of positive charge results that is equivalent to the difference in valence number with the substituted elements and the substituted amount, and in order to maintain the electrical neutrality of the crystal lattice, O(2−) having a negative charge is released resulting in the formation of oxygen defects.

In addition, lattice defects can be formed by (4) substituting a portion of a ceramic composite element other than oxygen with an element having a larger valence number than said element. If at least a portion of the Si, Al and Mg that are composite elements of cordierite are substituted with an elements having a larger valence number than those elements, an excess of positive charge results that is equivalent to the difference in valence number with the substituted elements and the substituted amount, and in order to maintain the electrical neutrality of the crystal lattice, a required amount of O(2−) having a negative charge is incorporated. The incorporated oxygen becomes an obstacle the prevents the cordierite crystal lattice from being arranged in an orderly manner, thereby resulting in the formation of lattice strain. The firing environment in this case should be an air atmosphere to provide an ample supply of oxygen. Alternatively, voids are formed by releasing a portion of the Si, Al and Mg in order to maintain electrical neutrality. Furthermore, since the size of these defects is considered to be several angstroms or less, specific surface area cannot be measured with ordinary methods for measuring specific surface area such as BET using nitrogen molecules.

The number of oxygen defects and lattice defects correlates with the amount of oxygen contained in the cordierite, and in order to allow loading of the above required amount of catalyst component, the amount of oxygen should be less than 47 wt % (oxygen defects) or greater than 48% (lattice defects). If the amount of oxygen becomes less than 47% due to the formation of oxygen defects, the number of oxygen contained in the cordierite unit crystal lattice becomes less than 17.2, and the lattice constant of axis b₀ of the cordierite crystal axis becomes less than 16.99. In addition, if the amount of oxygen exceeds 48 wt % due to the formation of lattice defects, the number of oxygen contained in the cordierite unit crystal lattice becomes greater than 17.6, and the lattice constant of axis b₀ of the cordierite crystal axis becomes greater or smaller than 16.99.

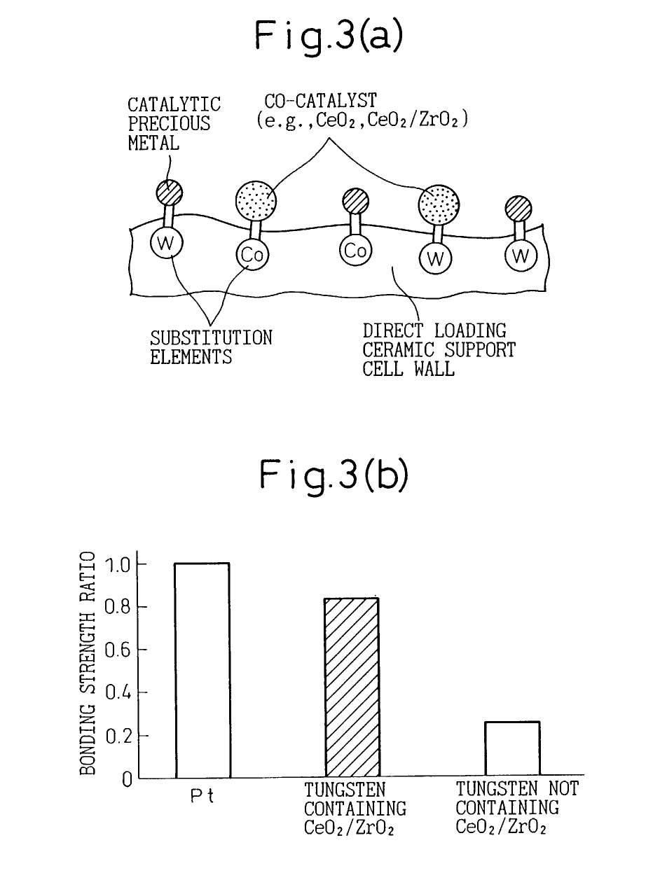

FIG. 4 is a ceramic catalyst body of the loading form of (2) above of a second embodiment of the present invention. In FIG. 4, a direct loading catalyst support, for example, has substitution elements in the form of W and Co introduced into cordierite serving as the base ceramic, and a main catalyst element in the form of a catalytic precious metal is chemically bonded to these substitution elements, a large number of which are present on cell wall surfaces forming a honeycomb structure. On the other hand, a co-catalyst component is loaded in the form of a co-catalyst layer that thinly covers the entire surface of the base ceramic by being directly coated onto the base ceramic surface. More specifically, a direct loading ceramic support that has been loaded with a main catalyst component in the form of a catalytic precious metal using a method similar to (1) above should be immersed in a solution in which a co-catalyst component such as CeO₂ or CeO₂/ZrO₂ has been dispersed in a solvent such as water, and after removing the support, the support should then be dried and baked. The constitution of the direct loading ceramic support, specific examples of main catalyst components and co-catalyst components and other matters are the same as in the previously described first embodiment.

According to this form of loading, since chemical bonding to substitution elements introduced into the base ceramic only applies to the catalytic precious metal serving as the main catalyst component, the amount of main catalyst component that is loaded can be increased beyond that of the above first embodiment. Normally, if the loaded amount of main catalyst component increases, the interval between catalysts becomes smaller resulting in a greater risk of deterioration due to aggregation. In the present invention, however, since the bonding strength between each catalyst particle and the base ceramic is large, there is little deterioration. In addition, as a result of loading a co-catalyst component onto the surface of the base ceramic in the form of a co-catalyst layer, the loaded amount of co-catalyst component can be easily adjusted, thereby facilitating control of the amount of stored oxygen and so forth.

Furthermore, the thermal capacity and pressure loss of the ceramic catalyst body increases slightly as compared with the constitution of the above first embodiment as a result of forming the co-catalyst layer. In order to inhibit increases in thermal capacity and pressure loss, the co-catalyst layer should be as thin as possible, and should normally be formed to 100 μm or less. However, if the thickness of the co-catalyst layer is less than 0.5 μm, in addition to it becoming difficult to form the co-catalyst layer, the action of the co-catalyst decreases, while if the thickness of the co-catalyst layer exceeds 95 μm, since purification performance tends to decrease, the thickness should preferably 0.5-95 μm, and more preferably 20-80 μm. The loaded amount of co-catalyst component should normally be within the range of 20-150 g/L, and preferably 40-90 g/L. However, since the optimum values differ according to the type and required properties of the co-catalyst component, the above ranges do not always apply. As a result, co-catalyst function can be imparted while minimizing increases in thermal capacity and pressure loss (to ⅙ or less those of a conventional three-way catalyst). In addition, since the catalytic precious metal and co-catalyst component are in close proximity to each other, catalyst performance can be demonstrated effectively.

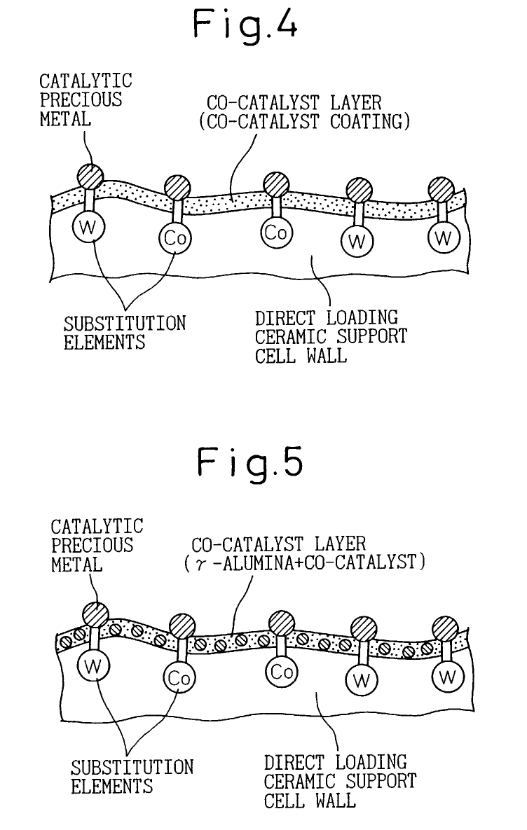

FIG. 5 is a ceramic catalyst body of the loading form of (3) above of a third embodiment of the present invention. In FIG. 5, a direct loading ceramic support has, for example, substitution elements in the form of W and Co introduced into cordierite serving as the base ceramic, and a main catalyst component in the form of a catalytic precious metal is chemically bonded to these substitution elements present in large number on cell wall surfaces forming a honeycomb structure. On the other hand, a co-catalyst component is coated onto the surface of the direct loading ceramic support together with an intermediate base material, and is loaded in the form of a co-catalyst layer that thinly covers the entire surface of the base ceramic.

The intermediate base layer is located between the direct loading ceramic support and the co-catalyst component, and holds the co-catalyst component. One or more types of ceramics having a larger specific surface area than the base ceramic is preferably used for this intermediate base layer, and are selected from alumina (γ-, θ- or α-Al₂O₃), SiO₂.Al₂O₃ systems, SiO₂.MgO systems, zeolite systems (type X, Y, A or ZSM-5), activated charcoal, SiO₂, MgO, TiO₂, ZrO₂, Al₂O₃.ZrO₂, Al₂O₃.TiO₁, TiO₂.ZrO₂, SO₄/ZrO₂, SO₄/ZrO₂.TiO₂, SO₄/ZrO₂Al₂O₃, 6Al₂O₃.BaO, 11Al₂O₃.La₂O₃, silicalite and mordenite. The average particle diameter of the intermediate base layer should be 200 μm or less, and preferably 50 μm or less.

Loading of the catalyst components should be carried out by loading the main catalyst component in the form of a catalytic precious metal onto the direct loading ceramic support according to the same method as (1) above, followed by immersing the support in a solution which a co-catalyst component such as CeO₂ or CeO₂/ZrO₂ and an intermediate base material have been dispersed in a solvent such as water, and then removing the support, drying and baking. Alternatively, the catalyst components can also be loaded by a method in which an extremely thin layer of the intermediate base material is coated followed by coating the co-catalyst component.

In either case, in order to inhibit increases in thermal capacity and pressure loss, the co-catalyst layer is normally formed to 100 μm or less. Although the thinner the co-catalyst layer, the lower the thermal capacity and pressure loss, if the thickness of the co-catalyst layer is less than 0.5 μm, in addition to it becoming difficult to form the co-catalyst layer, the action of the co-catalyst decreases. In addition, if the thickness of the co-catalyst layer exceeds 95 μm, purification performance tends to decrease. Thus, the thickness of the co-catalyst layer should preferably be 0.5-95 μm, and more preferably 20-80 μm. In addition, although the loaded amount of the co-catalyst component should normally be 10 g/L or more, preferably within the range of 20-150 g/L, and more preferably within the range of 40-90 g/L, since the optimum values differ according to the type and required properties of the co-catalyst component, the above ranges do not always apply. The amount of intermediate base material used is the amount capable of inhibiting increases in thermal capacity and pressure loss while retaining the co-catalyst component, and is preferably about 10-30 wt % of the loaded amount of co-catalyst component.

As a result, catalyst performance can be effectively demonstrated by imparting the function of a co-catalyst while minimizing increases in thermal capacity and pressure loss (to ⅓ or less those of a conventional three-way catalyst). In addition, since an intermediate base material is used, the loaded amount of co-catalyst component can be easily increased or decreased, which together with simplifying control of the amount of oxygen stored and so forth, since the co-catalyst component is retained on an intermediate base material having a large specific surface area, it is highly effective in inhibiting deterioration of the co-catalyst component.

The following indicates a production method of a ceramic catalyst body having the constitution shown in the aforementioned FIG. 5. In the co-catalyst layer, a compound oxide of cerium and zirconium was used for the co-catalyst component, while γ-alumina was used for the intermediate base material. The co-catalyst component was prepared by preliminarily dissolving cerium chloride and zirconium chloride in 1 L of nitric acid, and then neutralizing and co-precipitating the solution by addition of aqueous ammonium hydroxide to obtain cerium-zirconium compound oxide so that the weight ratios of ceria and zirconia were 10 wt % and 90 wt %, respectively.

A main catalyst component in the form of a catalytic precious metal was first loaded onto a direct loading ceramic support produced using the same method as the above ceramic catalyst body having the constitution of FIG. 1. Using 1 L of an aqueous solution containing as catalytic precious metals 0.075 mol/L of platinum nitrate tetraamine and 0.02 mol/L of rhodium acetate, a direct loading ceramic support was immersed using a similar method, and after pre-drying and then final drying, metal sintering was carried out. The loaded ratio of the catalytic precious metals after sintering was Pt/Rh 7/1, and the loaded amount was 1.2 g/L.

Next, 300 g of a powder of the co-catalyst component prepared in the above manner (cerium-zirconium compound oxide), 3 g of γ-alumina (1 wt % of co-catalyst component) and 900 g of pure water were placed in a beaker and stirred with a glass rod. Stirring time can be shortened by placing the beaker in an ultrasonic cleaner during stirring. Once the mixture had become uniform, a direct loading ceramic support loaded with catalytic precious metal was immersed in the liquid and left in the beaker with the ultrasonic cleaner still operating. After 5 minutes had elapsed, the support was removed and air blown at an air pressure of 0.2 MPa to remove clogging. Subsequently, the support was pre-dried for 10 minutes with a microwave dryer followed by final drying for 2 hours at 110° C. Following completion of drying, the support was held for 1 hour at 900° C. for the purpose of sintering to complete loading of the catalyst component. The loaded amount of co-catalyst component was 40 g/L.

According to the above method as well, a ceramic catalyst body is obtained that is loaded with the required amounts of main catalyst component and co-catalyst component. In particular, by employing a technique in which a co-catalyst component is loaded directly onto a support to form a co-catalyst layer on its surface, the loaded amounts of main catalyst component and co-catalyst component were confirmed to be able to be increased.

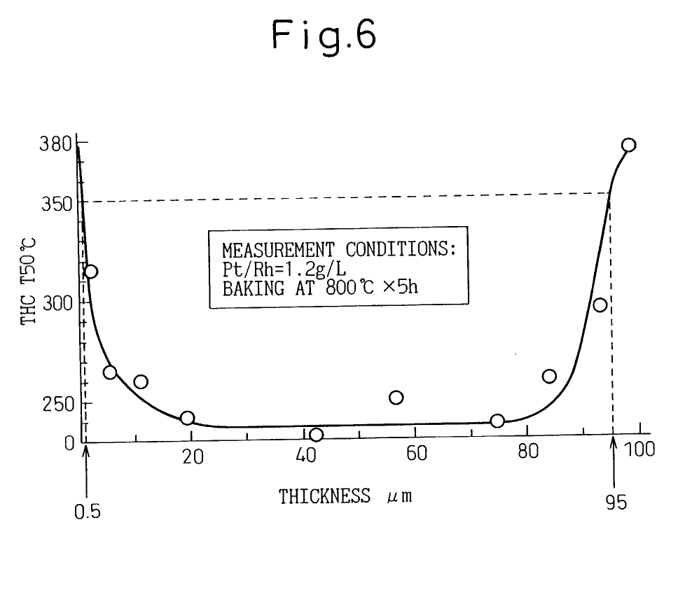

FIG. 6 is a graph showing the relationship between the thickness of the co-catalyst layer and the T50 purification temperature. An intermediate base material in the form of γ-alumina was coated onto the surface of a base ceramic loaded with a total of 1.2 g/L of main catalyst components in the form of Pt and Rh (baked for 5 hours at 800° C.) followed by loading of a co-catalyst component in the form of CeO₂ using the same method as described above to obtain a ceramic catalyst body. The temperature at which the purification rate becomes 50% (T50 purification temperature) was measured after introducing a model gas containing hydrocarbons (HC) into various samples in which the thickness of the co-catalyst layer was changed. As is clear from the graph, purification performance improved rapidly as the thickness of the co-catalyst layer became greater than 0 μm or smaller than 100 μm, with the T50 purification temperature being 350° C. or lower when the thickness was 0.5-95 μm. In addition, when the thickness was 20-80 μm, the T50 purification temperature was below 250° C., thereby confirming the obtaining of high performance.

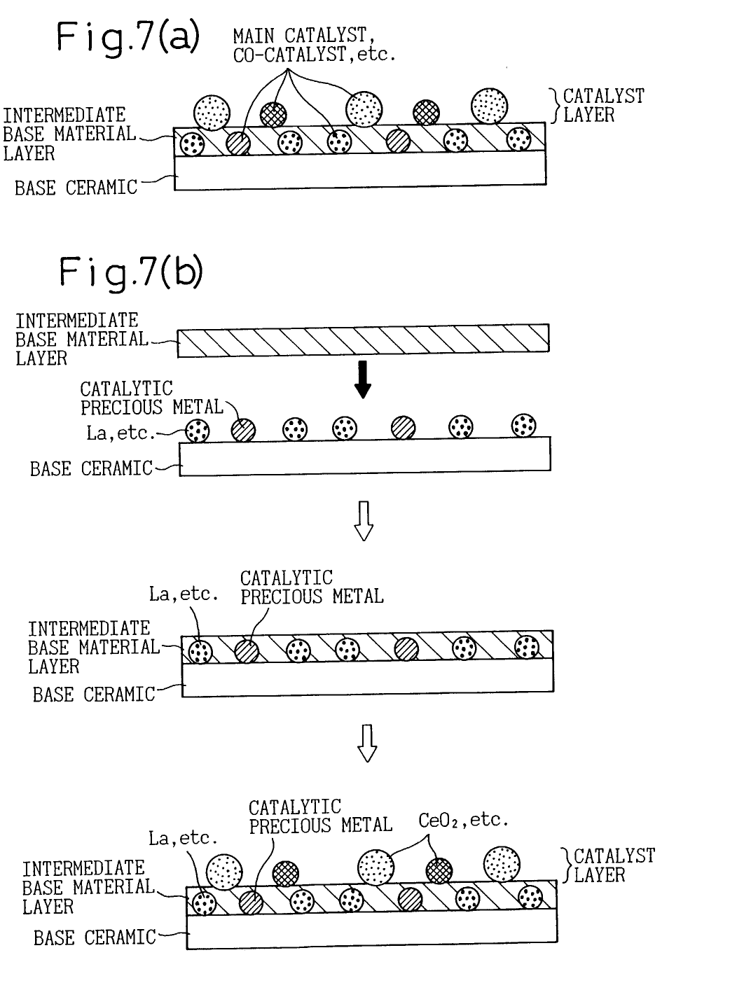

FIGS. 7(a) and 7(b) shown an example of a ceramic catalyst body of the loading form shown in FIG. 4 above of a fourth embodiment of the present invention. In FIG. 7(a), a direct loading ceramic support has the same constitution as each of the above embodiments, and at least a portion of a main catalyst component and co-catalyst component are loaded directly onto substitution elements present in large number on its surface. An intermediate base material layer such as γ-alumina is thinly coated on top of them, and the remaining main catalyst component and co-catalyst component are loaded onto this intermediate base material layer to form a catalyst layer.

As shown in FIG. 7(b), catalyst components that easily bond with the base ceramic and do not deteriorate even in the absence of an intermediate base material are preferably loaded onto the direct loading ceramic support. For example, the entirety of catalytic precious metals such as Pt, Rh, and Pd serving as the main catalyst components, and an element such as La that improves the heat resistance of the intermediate base layer as a portion of the co-catalyst component, are loaded. Loading of these catalyst components is carried out in the same manner as the above embodiments, and after immersing the support in a catalyst solution containing catalytic precious metals such as Pt, Rh and Pd, as well as La, the support is dried and then baked at a temperature from 100° C. to less than 1000° C. This is then placed in a slurry of an intermediate base material such as γ-alumina to form an intermediate base material layer on the cell wall surfaces, followed by baking at a temperature from 100° C. to less than 1000° C. and loading the other catalyst components.

In this case as well, the thickness of the catalyst layer that contains the catalyst components loaded onto the intermediate base material layer is 100 μm or less, preferably 0.5-95 μm, and more preferably 20-80 μm. Examples of catalyst components loaded onto the intermediate base material include those that enhanced retention or those that facilitate increasing or decreasing the loaded amounts as a result of loading, for example, an oxygen storage component such as CeO₂ or CeO₂/ZrO₂ and so forth onto the intermediate base material layer. Here, a remaining co-catalyst component such as CeO₂ is loaded. These catalyst components can also be loaded by a similar method in which a support is immersed in a catalyst solution followed by baking at a temperature from 100° C. to less than 1000° C. Alternatively, a catalyst layer may also be formed by coating an intermediate base material loaded with a co-catalyst component in advance.

According to this loading method, since the optimum loading method can be selected according to the catalyst components used, it is highly effective in inhibiting deterioration of each catalyst component. In addition, although an element such as La is added directly to a coating layer such as γ-alumina in, for example, a support constitution of the prior art, in the present embodiment, since an element such as La is first fixed to a direct loading ceramic support, it is no longer necessary to uniformly mix into the γ-alumina and so forth serving as the intermediate base material layer, thereby making it possible to reduce costs. An element such as La is dispersed by the application of heat without mixing in advance, and equal heat resistance effects are obtained. Examples of elements other than La that have equivalent effects include Ba, Ce, Zr and Si, and an oxide or compound oxide can be used that contains these elements. In addition, since the amount of catalyst components loaded onto the intermediate base material layer is lower than the constitution of the prior art, the intermediate base material layer, namely the catalyst layer, can be made to be thinner. Accordingly, both decreases in thermal capacity and pressure loss as well as improvements in catalyst performance and durability can be realized.

The effects of La in the ceramic catalyst body having the constitution shown in FIGS. 7(a) and 7(b) above were confirmed in the manner described below. A direct loading ceramic support produced in the same manner as the above first embodiment was immersed in a solution of La and main catalyst components consisting of Pt, Rh and Pd followed by baking the catalyst at 600° C. This was then immersed in a slurry of γ-alumina and baked at 600° C. to form an intermediate base material layer. Evaluation was carried out by measuring the specific surface area by BET adsorption and nitrogen adsorption for two samples obtained immediately after baking of the alumina and after aging at 1000° C. for 24 hours after baking. In addition, for the sake of comparison, a sample was also produced by the same method with the exception of not loading La, and the specific surface area of this sample was also measured. The loaded amount of γ-alumina was 30 g/L, and the loaded amount of La was 2.5 g/L.

As a result, as shown below, a decrease in the specific surface area of the alumina of the upper layer was confirmed to be able to be inhibited by La directly loaded onto the base ceramic.

| Specific surface area | No La loading | La loading |
|---|---|---|
| Immediately after | 155 m²/g | 150 m²/g |
| baking alumina | | |
| After aging treatment | 2 m²/g | 21 m²/g |

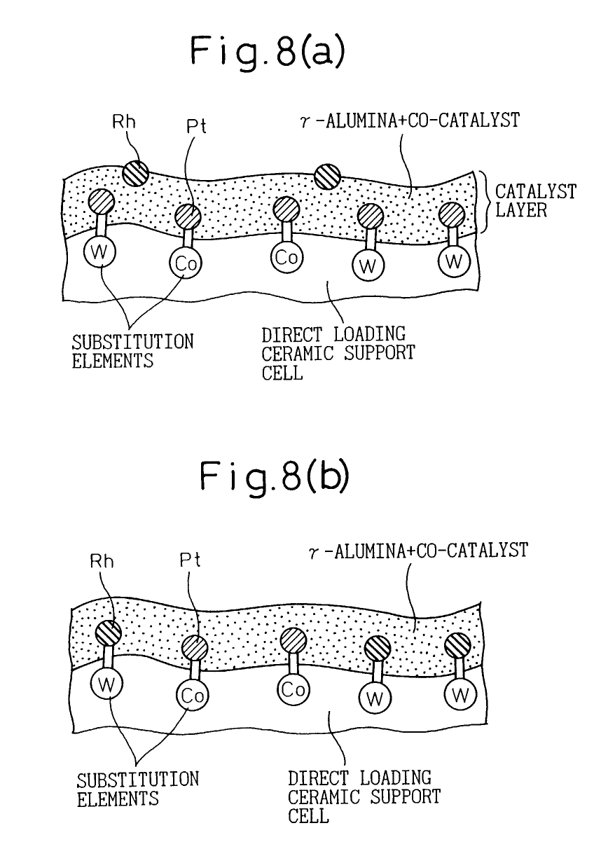

FIG. 8(a) shows another example of a ceramic catalyst body of the loading form of (4) above of a fifth embodiment of the present invention. In FIGS. 8(a) and 8(b), the direct loading ceramic support has the same constitution as the each of the above embodiments. In a fourth embodiment of the above FIG. 7(a), although a constitution was employed in which the entirety of the main catalyst component was loaded directly onto substitution elements present in large number on the surface of a direct loading ceramic support, in the present embodiment, only a portion of the main catalyst component in the form of catalytic precious metal is loaded directly onto a direct loading ceramic support, while the remaining catalytic precious metal and co-catalyst component are coated together with an intermediate base material to form a catalyst layer.

In FIG. 8(a), one or more types of catalytic precious metals such as Pt, Rh and Pd serving as the main catalyst component, for example Pt, is loaded onto a direct loading ceramic support. Loading of Pt is carried out in the same manner as the above embodiments using a method in which, after immersing in a catalyst solution containing Pt, the ceramic support is dried and then baked at a temperature from 100° C. to less than 1000° C. Next, the support is immersed in a solution in which co-catalyst component and intermediate base material are dispersed in a solvent such as water followed by drying and backing at a temperature from 100° C. to less than 1000° C. to form a layer containing the co-catalyst component and intermediate base material.

An oxygen storage components such as CeO₂ or CeO₂/ZrO₂ is used for the co-catalyst component, while γ-alumina and so forth is used for the intermediate base material. This is then placed in a slurry of the intermediate base material to form a layer containing co-catalyst component and intermediate base material on the cell wall surfaces followed by loading one or more types of catalytic precious metal such as Rh to form a catalyst layer. Loading of Rh can also be carried out by a method similar to immersing in a catalyst solution containing Rh. Alternatively, loading can also be carried out by simultaneously adding Rh during formation of a layer containing co-catalyst component and intermediate base material. In this case as well, the thickness of the catalyst layer containing catalyst components loaded on an intermediate base material should be 100 μm or less, preferably 0.5-95 μm, and more preferably 20-80 μm.

Although bonding strength can be enhanced as a result of directly loading onto the surface of a direct loading ceramic support since catalytic precious metals such as Pt, Rh and Pd bond easily with the base ceramic, as shown in FIG. 8(b), in a constitution in which a co-catalyst component is coated thereon together with an intermediate base material, since the catalytic precious metal has difficulty appearing on the surface and is located at a distance from the co-catalyst component, there are cases in which the properties of the co-catalyst component cannot be utilized. In such cases, as indicated in the present embodiment, together with ensuring the desired loaded amount and bonding strength by directly loading a portion of catalytic precious metal onto the surface of the direct loading ceramic support, by forming a catalyst layer in which the remaining catalytic precious metal is loaded onto an intermediate base material together with the co-catalyst component, the distance between the catalytic precious metal and co-catalyst component can be reduced. Accordingly, since the properties of the co-catalyst component are effectively demonstrated, and the catalytic precious metal appears easily on the surface, low-temperature activity performance can be expected to improve.

Furthermore, although two different types of catalytic precious metals were used in the present embodiment for the catalytic precious metal directly loaded onto the surface of the direct loading ceramic support (Pt) and the catalytic precious metal that forms the catalyst layer together with the co-catalyst component (Rh), the same type of catalytic precious metals may also be used. In addition, either or both may also be a plurality of types of catalytic precious metals.

The effects of the ceramic catalyst body having the constitution shown in the above FIG. 8(a) were confirmed in the manner described below. A direct loading ceramic support produced using the same method as the above first embodiment was immersed in a solution of a main catalyst component in the form of Pt using the above method, and then the catalyst was baked at 600° C. Next, a solid portion consisting of a 1:4 mixture of γ-alumina containing boemite binder at a ratio of 6 wt % and co-catalyst component in the form of CeO₂ was produced, and 900 g of pure water were mixed with 45 g of this solid portion to create a slurry. A direct loading ceramic support loaded with Pt was immersed in a beaker containing the above slurry followed by degassing and impregnating for 5 minutes with an ultrasonic cleaner. The support was then blown with air and fired for 1 hour at 900° C. to form an intermediate base material layer containing the co-catalyst component.

Moreover, an aqueous solution was prepared to a rhodium acetate concentration of 0.02 mol/L in order to load the main catalyst component in the form of Rh. The above direct loading ceramic support was immersed in a beaker containing this solution and then degassed and impregnated for 1 minute with an ultrasonic cleaner. By then drying for 1 hour at 110° C. and then metal firing for 2 hours at 300° C., Rh unevenly distributed in the intermediate base material layer containing the co-catalyst component was loaded onto the ceramic support. The loaded amount of Rh was 0.2 g/L.

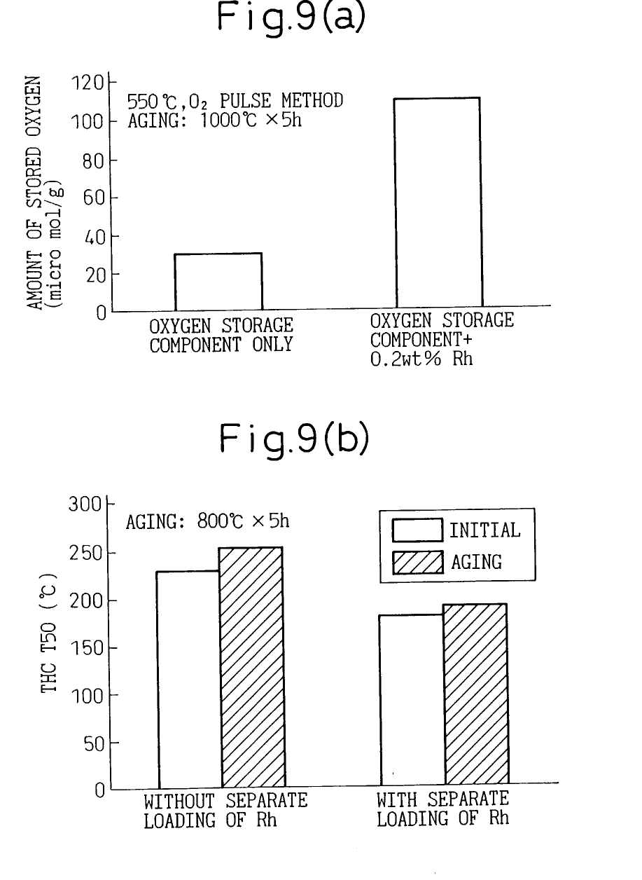

Aging was carried out on the resulting sample for 5 hours at 1000° C. followed by evaluation based on measurement of the amount of stored oxygen. Measurement of the amount of stored oxygen was carried out by the pulse method at 550° C. In addition, for the sake of comparison, a sample was produced having the constitution of FIG. 8(b) in which Pt and Rh were loaded directly onto a direct loading ceramic support, followed by coating an oxygen storage component thereon together with an intermediate base material, after which the amount of stored oxygen of this comparison sample was measured. As a result, as shown in FIGS. 9(a) and 9(b), in the constitution of the present embodiment having a catalyst layer in which an oxygen storage component and Rh are loaded on an intermediate base material, in comparison with the constitution of FIG. 8(b) having only an oxygen storage component, the oxygen storage capacity following aging is considerably improved.

In addition, the T50 purification temperatures were measured for each of the samples both immediately after baking of the catalyst components and after aging for 5 hours at 800° C. As is clear from FIGS. 9(a) and 9(b), as a result of employing the constitution of the present embodiment, the T50 purification temperatures were lower both immediately after baking (initial) and after aging, and as a result of Rh being loaded on the surface layer, low-temperature activity performance was confirmed to improve considerably.

What is claimed is:

1. A ceramic catalyst body comprising the loading of a main catalyst component and a co-catalyst component onto a ceramic support; wherein, said ceramic support is a ceramic support capable of directly loading a catalyst component on the surface of a base ceramic, and said main catalyst component and said co-catalyst component are loaded directly onto said ceramic support.

2. The ceramic catalyst body according to claim 1 wherein, said co-catalyst component contains an oxygen storage component.

3. The ceramic catalyst body according to claim 1 wherein, said co-catalyst component contains a transition metal element.

4. The ceramic catalyst body according to claim 3 wherein, said transition metal element is put into solid solution or substituted with an oxygen storage component.

5. The ceramic catalyst body according to claim 3 wherein, said transition metal element is put into solid solution or substituted with an oxygen storage component, and said co-catalyst component is loaded directly by bonding by said transition metal element with the base ceramic of said ceramic support.

6. A ceramic catalyst body comprising the loading of a main catalyst component and a co-catalyst component onto a ceramic support; wherein, said ceramic support is a ceramic support capable of directly loading a catalyst component on the surface of a base ceramic, and together with said main catalyst component being loaded directly onto said ceramic support, a co-catalyst layer containing said co-catalyst component is formed on the surface of said ceramic support.

7. A ceramic catalyst body comprising the loading of a main catalyst component and a co-catalyst component onto a ceramic support; wherein, said ceramic support is a ceramic support capable of directly loading a catalyst component on the surface of a base ceramic, and together with said main catalyst component being loaded directly onto said ceramic support, a co-catalyst layer comprised by directly coating said co-catalyst component is formed on the surface of said ceramic support.

8. A ceramic catalyst body comprising the loading of a main catalyst component and a co-catalyst component onto a ceramic support; wherein, said ceramic support is a ceramic support capable of directly loading a catalyst component on the surface of a base ceramic, and together with said main catalyst component being loaded directly onto said ceramic support, a co-catalyst layer comprised by coating said co-catalyst component together with an intermediate base material is formed on the surface of said ceramic support.

9. The ceramic catalyst body according to claim 8 wherein, said co-catalyst layer is formed by coating said co-catalyst component onto an intermediate base material layer formed on the surface of said ceramic support, or by coating an intermediate base material pre-loaded with said co-catalyst component onto the surface of said ceramic support.

10. A ceramic catalyst body comprising the loading of a main catalyst component and a co-catalyst component onto a ceramic support; wherein, said ceramic support is a ceramic support capable of directly loading a catalyst component on the surface of a base ceramic, and together with at least a portion of said main catalyst component and said co-catalyst component being loaded directly onto said ceramic support, a catalyst layer containing the remaining said main catalyst component and said co-catalyst component is formed on the surface of said ceramic support.

11. The ceramic catalyst body according to claim 10 wherein, said catalyst layer is formed by coating said main catalyst component or said co-catalyst component onto an intermediate base material layer formed on the surface of said ceramic support, or by coating an intermediate base material pre-loaded with said main catalyst support or said co-catalyst support onto the surface of said ceramic support.

12. The ceramic catalyst body according to claim 10 wherein, together with using one or more types of catalytic metal for said main catalyst component and directly loading a portion thereof onto said ceramic support, the remaining said catalytic metal is contained in said catalyst layer.

13. The ceramic catalyst body according to claim 8 wherein, said intermediate base material has a specific surface area larger than the base ceramic of said ceramic layer.

14. The ceramic catalyst body according to claim 13 wherein, said intermediate base material is one more types of materials selected from Al₂O₃, SiO₂, MgO, TiO₂, ZrO₂, zeolite, silicalite and mordenite.

15. The ceramic catalyst body according to claim 1, 6, 7, 8 or 10 wherein, said co-catalyst component contains an oxygen storage component comprised of an oxide containing at least one or more elements selected from lanthanide elements as well as Y, Zr and Hf.

16. The ceramic catalyst body according to claim 7, 8 or 10 wherein, the thickness of said co-catalyst layer or said catalyst layer is 100 μm or less.

17. The ceramic catalyst body according to claim 16 wherein, the thickness of said co-catalyst layer or said catalyst layer is 0.5-95 μm.

18. The ceramic catalyst body according to claim 1, 6, 7, 8 or 10 wherein, at least one or more types of the elements that compose said base ceramic is substituted with an element other than a component element, and said ceramic support is able to directly load said catalyst component or said co-catalyst component for that substitution element.

19. The ceramic catalyst body according to claim 18 wherein, said catalyst component or said co-catalyst component is loaded on said substitution element by chemical bonding.

20. The ceramic catalyst body according to claim 19 wherein, said substitution element is at least one or more types of elements having a d orbital or f orbital in its electron orbitals.

21. The ceramic catalyst body according to claim 1, 6, 7, 8 or 10 wherein said base ceramic has cordierite for its main component.

22. The ceramic catalyst body according to claim 1 wherein, said ceramic support has a large number of fine pores capable of directly loading a catalyst onto the surface of said base ceramic, and is capable of directly loading said catalyst component or said co-catalyst component for these fine pores.

23. The ceramic catalyst body according to claim 22 wherein, said fine pores are composed of at least one type of defect in the ceramic crystal lattice, fine cracks in the ceramic surface and deficiency in the elements that compose the ceramic.

24. The ceramic catalyst body according to claim 23 wherein, the width of said fine cracks is 100 nm or less.

25. The ceramic catalyst body according to claim 23 wherein, said fine pores have a diameter or width of 1000 times or less the diameter of the catalyst ions that are loaded, and the number of said fine pores is 1×10¹¹/L or more.

26. The ceramic catalyst body according claim 1 wherein, said base ceramic has cordierite for its main component, and said fine pores are composed of defects formed by substitution of a portion of the composite elements of the cordierite with metal elements having a different valence number.

27. The ceramic catalyst body according to claim 26 wherein, said defects are composed of at least one type of oxygen defect or lattice defect, and contain 4×10⁻⁶% of cordierite crystals having one or more of said defects in the unit crystal lattice of the cordierite.
